(19) United States
(12) Patent Application Publication
(10) Pub. No.: US 2009/0024361 A1
(43) Pub. Date: Jan. 22, 2009

(54) MINIATURE MEASURING DEVICE

(75) Inventors: Pascal Ransch, Meylan (FR); Nelly Bertin, Plouzane (FR)

Correspondence Address: CANTOR COLBURN, LLP, 20 Church Street, 22nd Floor, Hartford, CT, 06103, US

(73) Assignee: INTUISKIN, Crolles (FR)

(21) Appl. No.: 12/159,705

(22) PCT Filed: Dec. 7, 2006
(86) PCT No.: PCT/FR06/51309

§ 371 Date: Jun. 30, 2008

(30) Foreign Application Priority Data
Dec. 28, 2005 (FR) 0554122

(51) Int. Cl. G06F 19/00

(52) U.S. Cl. 702/189

(57) ABSTRACT

Device for measuring at least one physicochemical parameter of the surrounding environment, said device including
at least one sensor suitable for delivering a signal representing a measurement of the physicochemical property;
a display member suitable for generating visual information representing the the measurement;
a processing unit suitable for conditioning the signal delivered by the sensor for displaying the visual information by means of the display member,
an electric power source for supplying the sensor, the display member and the processing unit;
a main body integrating the sensor; and
a cap covering said sensor.

### TECHNICAL FIELD

The invention relates to the field of cosmetology and dermatology. It relates more particularly to a portable and self-contained miniaturised apparatus for analysing at least one physicochemical parameter of the surrounding medium, such as a cutaneous surface or the external environment.

### PRIOR ART

In fact, in general, apparatus for measuring a physicochemical property of a cutaneous surface comprise both a computerised processing unit and a set of sensors positioned in a probe placed in contact with the cutaneous surface.

Furthermore, such apparatus are not intended to take measurements of parameters of the external environment such as the temperature or humidity of the air. In fact, these apparatus are only used indoors and are not intended to be transported outside the room where they are installed.

Moreover, and as described in document CH-678 228, apparatus are also known for taking a measurement of the external environment, such as the intensity of light radiation, the humidity and temperature of the air, in the form of cards on which a sensor is positioned. However, such a device is very fragile, and in particular, the sensor is liable to be damaged when this apparatus is transported by a user. Furthermore, such a device is unfit for taking the measurement of a parameter of a physicochemical property of a cutaneous surface.

However, a real need exists for the ability to advise the user that a predefined threshold of a measurement of a physicochemical property has been reached, for example to advise the user that he must protect his epidermis by retiring to the shade or by using a protective creme. In fact, by taking the measurement of a parameter of a physicochemical property, it is possible in particular to anticipate and prevent the formation of “sunburn” or of any epidermal reaction due to exposure to sunlight.

Thus, it is the object of the invention to provide a safe, simple and effective solution for taking a measurement suitable for advising a user about the conditions of the external environment and also about the level of a physicochemical property of his skin.

It is a further object of the invention to permit the measurement of at least one physicochemical parameter of the surrounding medium, which is both portable and sufficiently robust to withstand impact during its transport.

### SUMMARY OF THE INVENTION

The invention therefore relates to a device for measuring at least one physicochemical parameter of the surrounding environment. Such a device comprises:
at least one sensor suitable for delivering a signal representing a measurement of the physicochemical property;
a display member suitable for generating visual information representing the said measurement;
a processing unit suitable for conditioning the signal delivered by the sensor for displaying the visual information by means of the display member;
an electric power source for supplying the said sensor, the display member and the processing unit;
a main body integrating the sensor;
a cap covering the sensor.

In other words, such a measuring device enables its user to take measurements of the surrounding medium, which may be the external environment, by using an atmosphere sensor, and also a cutaneous surface, using a body sensor.

The signal generated by the sensor is then processed by a processing unit to produce a signal suitable for generating visual information by means of a display member. For this purpose, an electric power source serves to supply the sensor, the display member and the processing unit.

When the sensor is not in use, it is protected inside the rigid envelope of the measuring device. This rigid envelope is made of a main body on which the sensor is arranged and a cap serving to cover the sensor entirely and to generate a rigid undeformable volume with the main body.

According to a particular embodiment, the sensor may be arranged on a support that is movable translationally relative to a fixed portion of the main body.

In other words, once the measurement is taken, the sensor can be retracted into the volume of the main body by a translational movement. In this way, the cap can cover the sensor by merely closing the recess in which the sensor is inserted.

When a measurement needs to be taken, the cap is then removed from the main body and the sensor is then extended outside the inner volume of the fixed portion of the main body.

In practice, the main body may comprise a portion that is movable relative to the fixed portion. This movable portion is then suitable for translationally moving the movable support.

Numerous solutions are in fact conceivable in order to impart a translational movement to the movable support. Mention can be made in particular of the use of a rotationally movable portion having a thread in order to provide a “nut and endless screw” type linkage. In this case, the translationally movable support has an inner thread cooperating with the threads of the movable portion. The movable support also comprises a translational guide member preventing the rotation thereof relative to the fixed portion of the main body. Such a translational guidance can be provided by means of a flat, a groove or any other particular shape extending lengthwise along the whole outer surface of the translationally movable support in the direction of the translational movement. The main body then comprises a matching lengthwise groove on its inner surface.

Another exemplary embodiment may consist in extending a portion of the movable support outside the volume defined by the fixed portion. The movable portion, suitable for moving the support, may be in the form of a cursor that is also moved translationally by the user.

For certain particular applications and especially to alert the user that a measurement is to be taken or that a measurement has exceeded a predefined threshold in intensity or duration, the measuring device may comprise a buzzer suitable for generating an acoustic signal.

In fact, the device can be used in order to take an instantaneous measurement for certain applications. It may also be used continuously to take a plurality of measurements at regular time intervals without the need for the user to open or close the cap. This plurality of measurements can then be used to integrate the measurements over a predefined period which can then be compared with a predefined threshold value, in particular to define the quantity of ultraviolet received by the sensor.

In this case, the user can, for example, be alerted that he must apply a protective creme to his skin in order to avoid sunburn.

In certain particular cases, the processing unit may comprise a data storage unit.

In this case, the measurements taken by the sensor can be stored in the measuring device and the processing unit can perform logic operations on a plurality of measurements.

In certain particular cases, the measuring device may also allow the transfer of the data delivered by the sensor to a computerised system. In this case, the storage unit may be of the permanent memory type to store information representing the said measurement and to permit its subsequent transfer. The storage unit may thus comprise a capacity to store a substantial number of measurements without the need to transfer the data contained in the storage unit. Once the measurements are taken, the data can therefore be transferred to a computerised system for analysis. This storage capacity may also be used to store information such as identification codes, as well as calibration information, on the state of the sensor. Thus, it is therefore possible to compile a record of the measurements, and also to calculate a relative variation from one measurement to another.

In order to optimise the electric power consumption, the device may integrate an energy management system selectively activating and deactivating the various electrical members according to preprogrammed modes, thereby managing the various power modes. This system may integrate charging modes of the electric power source when the device is inserted in a specific charger.

The device may also comprise a switch to energise the sensor, the display member and the processing unit. Furthermore, the device may also comprise “man-machine” interfaces for performing numerous actions according to the version of the device used, the type of physicochemical measurement to be taken, and the selection of the algorithm.

The power source may be in the form of a cell or battery which, when a measurement of a physicochemical property of the surrounding environment must be taken, supplies the corresponding sensor, the processing unit, and the display member. When the measuring device is not used, the switch or the electric power management device serves to open the circuit to preserve the electric power stored in the battery and avoid its discharge.

In a first alternative, the electric power source may be a photovoltaic cell. This cell serves to supply electric power to the sensor, the processing unit and the display member. In this case, the power is therefore supplied by the ambient light, and then converted to electrical energy.

In a second alternative, the electric power source may be a microgenerator converting an external energy source to electric power by induction, Hall effect, magnetoresistive, piezoelectric, thermal or mechanical effect.

In a third alternative, the electric power source may also be of a chemical type such as a storage battery, a cell or other battery in particular.

According to a first embodiment, the sensor may be a body sensor suitable for delivering a signal representing a physicochemical property of a cutaneous surface.

In this case, the sensor may be in various forms and particularly in the form of a micro-camera. This camera may incorporate a lens and a light source for evaluating the dimensional or calorimetric properties of the skin. The micro-camera may be black/white or colour as required by the measurement to be taken. In fact, such a micro-camera may be suitable for measuring a wrinkle length, its depth, or even the diameter of a pigment spot forming a beauty spot.

In order to improve the taking and subsequent use of the image, an additional element may be associated with the micro-camera and particularly a lighting device, a wide-angle lens, a zoom or a specific wavelength filter.

According to a first alternative, the lighting may be provided by means of a light source inside the device.

According to a second alternative, the lighting may also be provided by means of an external light source.

Furthermore, regardless of the alternative used, the light source may comprise light emitting diodes (LED) or organic light emitting diodes (OLED) emitting in the same specific wavelength or several LEDs or OLEDs emitting in different wavelengths. These LEDs or OLEDs may be arranged in circular, triangular or rectangular arrangements around the camera.

The black/white or multicolour lighting modes may be selected by the apparatus automatically or by the user via one or more man-machine interfaces.

In a particular embodiment, a positioning aid may be integrated and provided by at least one oriented LED or OLED pointer. A pattern comprising a simple or complex geometry is projected on the area to be measured. The reflected image of this pattern can then be interpreted manually or automatically by the focusing device thereby adjusting the setting of the camera.

In the case in which a zoom is integrated, the system may have means for adjusting same.

The camera is connected to an electronic unit in charge of managing the setting parameters which are the shutter speed, aperture, or even the gain. The light and clarity measurements for adjustment are taken either through the lens of the camera, or by an additional sensor. The image captured by activating a control knob is stored in the onboard storage unit. The format of the captured image is preferably of the compressed type and compatible with the standard formats in force.

The system may integrate image processing algorithms. A man-machine interface, comprising at least one selection knob, enables the user to make a choice from one or more available algorithms according to the measurement that he wishes to take and in particular:
length of the wrinkles, small wrinkles or microstructures developed;
area of the wrinkled zones;
local or average roughness;
isotropy of the skin;
local or average colorimetry;
area of the hyperpigmentation zone;
measurement of lipids content;
concentration of hair on the skin.

According to the measurement of the body physicochemical property to be taken, the sensor may also be selected from the group comprising:
pH sensors;
cutaneous imprint sensors, suitable for measuring the topography of the cutaneous surface to be analysed;
skin moisture sensors;
skin temperature sensors;
lipids content sensors;
sensors of elastic deformation of the cutaneous surface to be analysed.

Obviously, for certain applications, the measuring device may comprise a plurality of sensors selected from this group and suitable for measuring different physicochemical properties.

The measurement of the skin pH serves to distinguish a high pH, of about 5.5, and a more acid pH, close to 5.

The skin moisture sensor serves to measure very accurately the parameter generally qualified as “Trans Epidermal Water Loss”, abbreviated TEWL.

This parameter corresponds to the evaluation of a phenomenon independent of the transpiration, reflected by the evaporation of water from the underlying layers of the epidermis. This measurement serves for example to monitor the hydrolipid film playing the role of a skin barrier function, and to determine the scale of dryness of the skin.

The cutaneous imprint sensor serves to produce a measurement of the various irregularities of the skin surface. This measurement can be taken by various principles such as a capacitive, piezoresistive, piezoelectric, optical or electromagnetic measurement. The determination of the topography of the zone to be analysed serves to measure the uniformity of the skin, the number of wrinkles, their length, area and average depth. The total area of the wrinkles can be determined by calculating the area occupied by the average and deep wrinkles, corresponding respectively to the wrinkles having a depth between 150 and 200 microns, and higher than 200 microns.

It is also possible to determine the intensity of the main lines, in order to determine the length of the deepest wrinkles. The determination of the volume of the main wrinkles serves to measure the evolution of these wrinkles over time.

The measurement of the skin roughness is also an important parameter, because it serves to approach the overall flatness of the skin by characterising it by a mean amplitude value which is the resultant of the various relief features compared to a flat surface. The measurement of this roughness parameter, and its development over time, serves to identify the smoothing of the skin after a particular treatment.

The measurement of the temperature or ambient humidity may serve to correct certain particular measurements, and particularly that of the skin moisture content, that is, the Trans Epidermal Water Loss. It also serves to analyse a diagnosis related to the atmospheric conditions.

The lipids content sensors serve to determine the status of the cutaneous lipids, particularly for dry skins. This measurement serves to distinguish skin dryness phenomena, and excessive sebum production phenomena.

The sensor of elastic deformation of the cutaneous surface to be analysed serves to measure the firmness and elasticity of the skin. This deformation sensor operates on the principle of the application of a vacuum to a zone of skin, during a constant period. Several successive aspirations can be performed in order to measure the depth of penetration of the skin in a part of the device. More precisely, this measurement can be taken via optical sensors or based on strain gauges for example.

The analysis of the various measurements obtained serves to distinguish the instantaneous deformations, corresponding to an elasticity mechanism, and the delayed deformations, which can be treated as a viscosity mechanism.

According to a second embodiment, the sensor may be an atmosphere sensor suitable for delivering a signal representing a measurement of a parameter of the external environment.

In other words, at least one atmosphere sensor serves to supply information according to a parameter of the external environment, such as the temperature, humidity, pressure or fixed or variable frequency electromagnetic wave radiation, such as ultraviolet, infrared, microwave or acoustic waves.

In certain particular cases, the device may comprise a plurality of sensors selected from the two groups previously described, that is body sensors and atmosphere sensors.

In fact, the measurement of the environmental conditions during or between two measurements of the skin provides information considerably improving the interpretation of the results. This is because since the skin is a living organ having a function of regulating exchanges between the human body and its surroundings, it constantly adjusts and modifies its properties according to the environmental conditions. The measurement of these conditions may sometimes even be indispensable for an accurate evaluation of the effectiveness of a cosmetic or medical treatment.

In other cases, it is advantageous to quantify the exposure of the skin to the environmental conditions as a warning of potential pathological risks. For example, controlled environments such as cold rooms, white rooms, blast furnaces, aircraft cockpits, are particularly harmful to the skin, or even the sunlight absorbed during sunbathing or a mountain walk.

According to a particular embodiment, the sensor may be produced from a micro-electromechanical system (MEMS). An alternative of active or passive sensors may operate according to the principle of MEMS type (micro-electro-mechanical system) technologies. These sensors are therefore produced according to technologies using semiconductor, insulating or metallic materials, and chemical machining methods employed in the microelectronics field. The use of MEMS type sensors serves to concentrate a large number of sensors on a particularly restricted zone, implanted on the device. This serves to obtain results representing a localised, uniform and characteristic zone.

Due to its very small size, the use of MEMS serves advantageously to decrease the power consumption and hence to increase the service life of the electric power source.

According to a particular embodiment, active electric subassemblies such as piezo and/or MEMS actuators can perform the measurement sensor control function previously described. This control device may be very useful for repositioning the measuring device on a zone of the skin undergoing treatment observation.

Thus, the MEMS may simultaneously integrate functions of measurement and control of its effectiveness by combining electrical and mechanical devices at very small scale and very low consumption, meeting the major requirements of the device.

In order to optimise the contact between the skin and the body sensor and therefore the efficiency of the measurement, a device for controlling the contact pressure, positioning or orientation, may be integrated in the device. The operating principle of this control device may be based on the specific properties of the materials used for the construction of the apparatus and/or the mechanical properties according to the deformations imposed by the specific cutout geometries and/or sandwich assembly arrangements between the various layers of material.

In practice, the device may integrate an active or passive calibration device as required. The calibration serves to correct potential drifts of the sensors and to adjust the operating point of the system according to the applications.

### BRIEF DESCRIPTION OF THE FIGURES

The manner in which the invention is implemented and the advantages thereof will appear clearly from the description of the embodiment that follows, provided for information and non-limiting, in conjunction with the appended figures in which:

FIG. 1 is a perspective view of the measuring device when it is not in use;

FIG. 2 is a perspective view of the measuring devices in operation.

### MANNER OF IMPLEMENTING THE INVENTION

As already stated, the invention relates to a miniaturised measuring device that can be easily transported by its user.

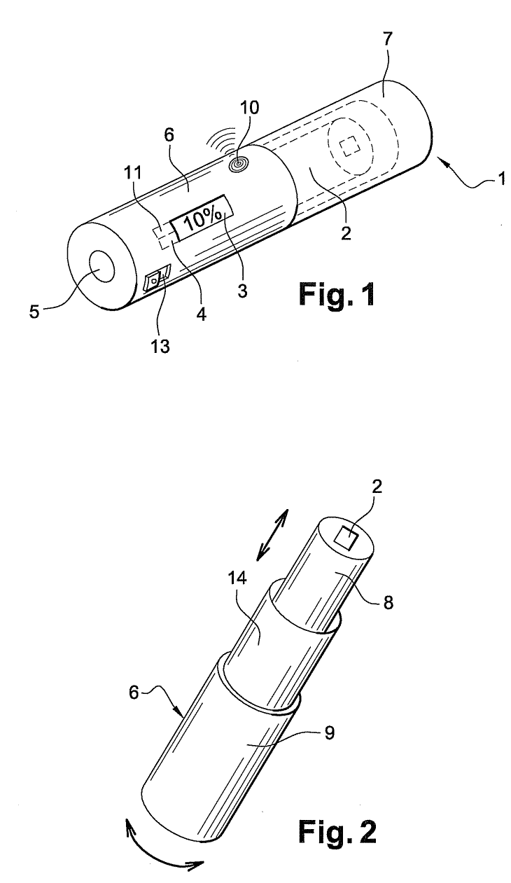

As shown in FIG. 1, a measuring device (1) comprises a main body (6) on which is arranged a sensor (2) for talking a physicochemical measurement of the external environment. When the device is transported and to avoid damaging the sensor (2), a cap (7) is used to cover a portion of the main body (6) on which the sensor (2) is arranged.

Such a device also comprises a display member (3) and a processing unit (4) for conditioning the signal delivered by the sensor (2) in order to generate visual information perceptible by the user. For this purpose, the device also comprises an electric power source (5) shown in the form of a battery and serving to supply the sensor (2), the display member (3) and the processing unit (4).

In certain particular cases, the processing unit (4) may also comprise a data storage unit (11), particularly for calculating a mean of the measurements taken instantaneously.

Furthermore, the device may comprise a switch (13) for energising the sensor (2), the processing unit (4) and the display member (3).

For certain applications, a buzzer (10) serves to alert a user by means of an acoustic signal in certain particular cases, such as in particular the overrun of a predefined threshold of a measurement of a parameter of the surrounding environment, and also to advise the user that a measurement is completed or should be taken.

As shown in FIG. 2, when the device is used, the cap is removed from the main body (6), in order to permit the measurement to be taken by means of the sensor (2). For this purpose, the sensor (2) may be arranged on a support (8) that can move translationally relative to a fixed portion (14) of the main body (6). Furthermore, according to a particular embodiment, the translational movement of the support (8) can be provided by means of a movable portion (9) linked pivotally to the fixed portion (14).

It appears from the above that a measuring device according to the invention has many advantages, in particular:
it serves to alert a user when a particular parameter of the surrounding environment is detected, or when the said parameter exceeds a predefined threshold value;
it can be transported very easily without any risk to its user;
it is compact and ergonomic so as to facilitate its use regardless of the circumstances or conditions of use.

1. Device for measuring at least one physicochemical parameter of the surrounding environment, said device comprising:
at least one sensor suitable for delivering a signal representing a measurement of the physicochemical property;
a display member suitable for generating visual information representing said measurement;
a processing unit suitable for conditioning the signal delivered by the sensor for displaying the visual information by means of the display member
an electric power source for supplying said sensor, the display member and the processing unit;
a main body integrating the sensor;
a cap covering the sensor.

2. Measuring device according to claim 1, wherein the sensor is arranged on a support that is movable translationally relative to a fixed portion of the main body.

3. Measuring device according to claim 2, wherein the main body comprises a portion that is movable relative to the fixed portion, said movable portion being suitable for moving said support.

4. Measuring device according to claim 1, further comprising a buzzer for generating an acoustic signal.

5. Measuring device according to claim 1, wherein the processing unit comprises a data storage unit.

6. Measuring device according to claim 1, further comprising a switch for energizing the sensor, the display member and the processing unit.

7. Measuring device according to claim 1, wherein the electric power source is a photovoltaic cell.

8. Measuring device according to claim 1, wherein the sensor is a body sensor suitable for delivering a signal representing a measurement of a physicochemical property of a cutaneous surface.

9. Measuring device according to claim 1, wherein the sensor is an atmosphere sensor suitable for delivering a signal representing a measurement of a parameter of the external environment.

10. Measuring device according to claim 1, wherein the sensor is made from micro-electromechanical systems (MEMS).
